(19) United States
(12) Patent Application Publication
(10) Pub. No.: US 2026/0273642 A1
(43) Pub. Date: Sep. 17, 2026

(54) Method and Device for Producing a Component

(71) Applicant: Bayerische Motoren Werke Aktiengesellschaft, Muenchen (DE)

(72) Inventors: Thiemo FIEGER, Olching (DE); Felix HAECKEL, Muenchen (DE); Nicolai SKRYNECKI, Grosskarolinenfeld (DE); Johannes STAEVES, Muenchen (DE)

(21) Appl. No.: 18/870,707

(22) PCT Filed: Oct. 9, 2023
(86) PCT No.: PCT/EP2023/077834

§ 371 Date: Dec. 2, 2024

(30) Foreign Application Priority Data
Oct. 10, 2022 (DE) 10 2022 126 075.5

(51) Int. Cl. B23K 9/04; B23K 101/00; B33Y 10/00; B33Y 40/20; B33Y 80/00

(52) U.S. Cl. CPC B23K 9/042; B33Y 10/00; B33Y 40/20; B33Y 80/00; B23K 2101/006

(57) ABSTRACT

A method and device for producing a component using additive production, the method comprising the steps of a) creating a main body in an additive manufacturing method, as a result of which the main body has a plurality of material layers that lie one above the other in a first build direction, and b) applying at least one material web onto the outer contour of the main body by applying a plasticized material strand such that the at least one material web connects several of the material layers to one another.

### BACKGROUND AND SUMMARY

This disclosure relates to a method and a device for producing a component using at least one additive production method.

There is a large number of additive production methods. All methods of this group are based on the so-called layer construction method. This means that components are generated layer by layer. This enables very complex components to be produced.

However, the components created using additive production methods have anisotropic material properties. “Anisotropy” in this context means that the properties of a material are different depending on the direction of force action. This is due to the layer-by-layer construction process, in which one layer after another is applied to one another. The construction direction typically corresponds to the z direction, thus the vertical axis in space. At the transition from one layer to the next, material weakening occurs due to poor layer adhesion. Components are typically significantly more stable and resilient transversely to the construction direction than along the construction direction. This problem ensures that the components have to be explicitly designed and simulated for additive methods. If a component which has previously been conventionally manufactured is created by an additive method applying layer by layer, premature component failure can occur.

Against this background, it is an object of the disclosure to specify a possibility for how improved components can be produced using additive production methods. In particular, the components are to meet high mechanical requirements.

A method for producing a component is specified having the following steps:
a) creating a main body in an additive manufacturing method, due to which the main body has a plurality of material layers which are located one on top of another in a first construction direction, and
b) applying at least one material web to the outer contour of the main body by applying a plasticized material strand so that the at least one material web connects multiple of the material layers to one another.

The component to be produced thus comprises, in addition to a main body, at least one material web. The desired external dimensions of the component are first achieved by the material web or multiple material webs. In addition to the main body and the at least one material web, the component can also comprise, for example, component elements which are also attached to the main body during the production of the main body or the application of the at least one material web. These component elements can be, for example, sheet-metal components, preferably sheet-metal profiles or cast components. The component elements can be designed, for example, as attachment elements for attaching the component to further components.

The component is preferably finalized by the at least one material web. The main body is created using an additive production method. In this case, the main body is constructed layer by layer in that a plurality of material layers are arranged in succession and one on top of another on a construction platform. A material layer is preferably created in a construction plane, wherein multiple construction planes are arranged one on top of another to create the main body. The material layers are preferably formed by applying and/or melting and solidifying material in multiple rows lying adjacent to one another. The direction in which the material layers lie one on top of another is referred to as the first construction direction. The main body can be formed using any additive manufacturing method, such as 3D printing, laser sintering, etc. and is preferably formed from a plastic material or a metal material or a metal alloy.

According to the disclosure, at least one material web is now applied to the outer contour of the main body so that the at least one material web connects several of the material layers to one another. The first material web is applied by depositing a plasticized material strand. Plasticizing refers in this case to the transition of a material from the solid into a deformable or free-flowing state; it is then plastically deformable. Preferably polymers and metal wires can be used as the printing material. The material web is applied to the outside of the main body and extends over several of the material layers of the main body already provided. In particular, the at least one material web can connect all layers of the main body to one another. For this purpose, a deviation is made from the first construction direction to apply the at least one material web. For example, the at least one material web can be applied to the outer contour of the main body inclined in relation to the first construction direction or transversely to the first construction direction. The anisotropic properties of the main body can be corrected in this way. Anisotropic properties in this context means that-because of the layer-by-layer construction-the main body has a tendency to have a weakness along the axis of the construction direction. In that one or more material webs now connect the layers of the main body to one another and are overlaid thereon, a higher component rigidity and longer component lifetime can be achieved.

The at least one material web is particularly preferably created by way of DED methods. The DED method (direct energy deposition method) refers to a 3D printing technology in which a material strand is created by way of a printing device having a nozzle and deposited layer by layer to form a 3D printed object. The printing material is plasticized (for example, by way of electric arc or laser radiation), transferred to the surface, solidifies there, and forms a material bond with the underlying material. The WAAM method is particularly preferably used as the DED method. In wire arc additive manufacturing (WAAM) a metal wire is melted using an electric arc and applied layer by layer to the component by way of a multiaxis manipulator in the desired form to create the desired material web. Using DED methods, especially WAAM, very high material application rates can be achieved, by which components can be produced significantly more cost-effectively than using other additive methods. In addition, components produced by DED methods have rougher surfaces, which are in turn better suitable for many post treatment methods such as dip coating. Moreover, material webs which are manufactured using this method are distinguished by a very high ductility upon use of a corresponding wire material.

In one preferred embodiment, it is provided that in step b) above, multiple material webs are applied adjacent to one another on the outer contour of the main body. Adjacent material webs preferably touch or overlap, so that they form a cohesive layer. In this way, an additional layer is formed on the outer contour which further strengthens the above-described effect.

With respect to a load path-compliant construction of the component, it is advantageous if in one embodiment the at least one material web or the multiple material webs extends/extend in the load direction of the component. The component strength can be increased in this way and the production of higher-performance components as possible.

In one variant, the method can comprise the following further step:
c) creating an auxiliary structure by applying at least one further material web to the at least one material web created in step b) above, in such a way that two or more material webs lie one on top of another in a second construction direction, wherein the second construction direction differs from the first construction direction and the second construction direction in particular extends transversely to the first construction direction. A selective material thickening is possible in this way, which enables radii or peaks in the underlying material structure to be compensated for. The risk of tension cracks can be reduced in this way. In addition, the auxiliary structure can be designed in the form of a reinforcing rib or the like. The auxiliary structure enables a longer component lifetime and provides new design freedoms with respect to the component geometry.

It is particularly preferred if the material web or the material webs or the auxiliary structure form at least one outer contour section of the component. In one embodiment, the material webs or the auxiliary structure can form the entire outer contour of the component. The outer contour of the component bears the majority of the component load. In that the material web or the material webs or the auxiliary structure also form the outer contour of the component, they can be formed compliant with the load path. Multiple degrees of freedom with respect to the construction direction of the main body thus result. This can be optimized with respect to rapid manufacturing. For example, the main body can be produced having a layered structure with minimal manufacturing time and is subsequently finalized by a load path-compliant outer contour or outer contour sections. A time saving and a cost reduction result in this way. Furthermore, stairstep effects on the component surface of the main body can be compensated for, which in turn results in a longer component lifetime. Furthermore, the necessity for finishing processes can be reduced.

It is particularly preferred if the component is a vehicle component and in particular a body structure component or a chassis component.

In a further aspect, the disclosure relates to a device for producing a component comprising a construction platform, which is arranged on a first positioning device, wherein the first positioning device is configured to rotate and tilt the construction platform in space. The construction platform can have any suitable shape and can have, for example, a flat plate and/or a support structure which is suitable for supporting the component to be produced. The construction platform can be positioned and held in space in a defined manner by the first positioning device for the method.

The device furthermore comprises a printing device having a nozzle for the emergence of a material strand, wherein the printing device is configured to plasticize the material strand. The term “plasticizing” is to be understood in this case to mean that the material is present in a deformable state or free-flowing state, in which it is plastically deformable. The material leaves the nozzle as a strand, i.e. as an uninterrupted piece of material.

The printing device is arranged on a second positioning device, which is configured to position the nozzle in space. The construction platform can be positioned and held in space in a defined manner by the first positioning device for the method.

The device furthermore includes a control device, which is configured to actuate the first positioning device and the second positioning device in order to position the construction platform and the nozzle in predetermined positions and to operate the printing device. For this purpose, the control device preferably has a corresponding operational connection to the positioning devices and the printing device.

In this device, it is particularly advantageous that the construction direction of the component body can be arbitrarily changed in relation to the platform and multiple construction directions can be implemented on a component body. The advantages already described for the method can be achieved in this way. Due to the mutual positioning capability of platform and nozzle, it is always possible to carry out the construction in the direction of the spatial vertical axis (z axis).

The positioning device is preferably an automated multiaxis system. In one preferred embodiment, the first positioning device and/or the second positioning device is a multiaxis, in particular at least 6-axis industrial robot. Free positioning in space, in particular in all six spatial axes, can be achieved by the multiaxis positioning device, by which optimum degrees of freedom are achieved. Furthermore, the industrial robot enables rapid positioning in a large working range and therefore the rapid production of even large components.

The printing device is preferably configured to provide a plasticized material strand made of a plastic material or made of a metal material. Such a printing device can be designed, for example, as a plastic extrusion head, by way of which a strand made of classified plastic material is output. For example, the printing device can also melt a metallic wire material by way of an energy source. For example, a resistance current or an electron beam can be used as an energy source. The use of a laser beam or electric arc is particularly preferred.

In one embodiment, the control device is configured to move the construction platform and nozzle at the same time, in particular while the printing device is operated. This enables the co-tilting or co-rotation of the component body while the material is applied. For example, component body and nozzle can each be arranged in relation to one another so that the material strand is applied essentially in the direction of the gravitational force and essentially perpendicularly to the component body surface. In this way, complex component surfaces can also be provided with an additional material web in optimum orientation. A better material application and a better attachment of the material to the already existing main body results.

It is particularly advantageous for the method if the creation of the main body and application of the at least one material web are carried out by way of the same above-described device. In this way, not only can the advantages and technical effects described for the device be achieved, but in addition the number of the required handling procedures is reduced to a minimum.

Features and details which are described in conjunction with the device also apply in conjunction with the method according to the disclosure and vice versa in each case, so that reference is or can always be made mutually to the individual aspects of the disclosure with respect to the disclosure.

Further advantages, features, and details of the disclosure result from the following description, in which exemplary embodiments of the disclosure are described in detail with reference to the drawings. The features mentioned in the claims and the description can each be essential to the disclosure individually as such or in any combination. Insofar as the term “can” is used in this application, this is both the technical possibility and the actual technical implementation.

### BRIEF DESCRIPTION OF THE DRAWINGS

Exemplary embodiments are explained hereinafter on the basis of the appended drawings.

FIG. 1 shows method steps for producing an exemplary component;

FIGS. 2 and 3 show exemplary method steps for producing further components; and,

FIG. 4 shows an exemplary device for carrying out the method.

### DETAILED DESCRIPTION OF THE DRAWINGS

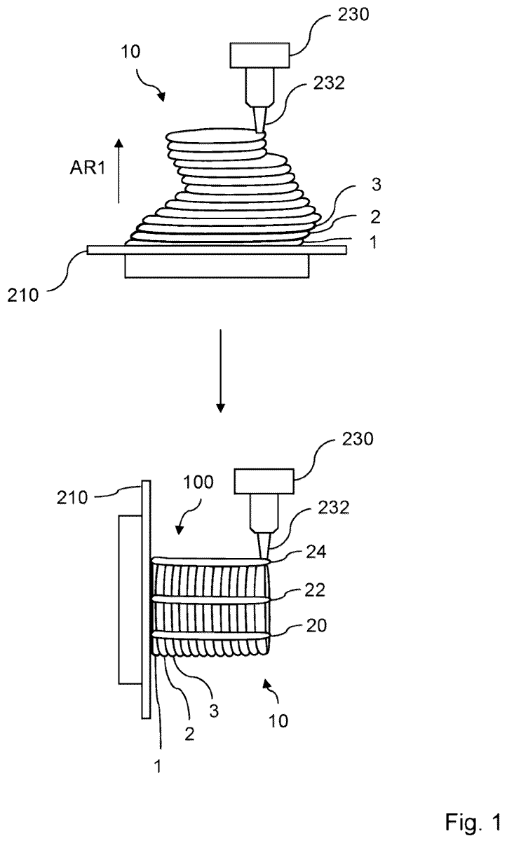

In the production method schematically shown in FIG. 1, initially a main body 10 is created by way of an additive manufacturing method on a construction platform 210. The main body is constructed from multiple material layers 1, 2, 3, . . . which are located one on top of another in a first construction direction AR1. The material layers 1, 2, 3, . . . are created in succession. For example, each material layer is created in a DED method, for which purpose a plasticized material strand is deposited by way of a printing device 230 from a nozzle 232 at a predetermined position. In principle, however, the main body 10 can also be created using any other additive manufacturing method.

To produce the component 100, after the creation of the main body 10, at least one material web 20 is applied to the outer contour of the main body. Three material webs 20, 22, and 24 are shown as examples in FIG. 1. The material webs are created by depositing the plasticized material strand by way of the printing device 230. For this purpose, the material webs 20, 22, 24 are arranged in relation to the main body 10 such that they connect several of the material layers 1, 2, 3, . . . to one another. FIG. 1 shows material webs which extend transversely over the material layers as examples. The material webs are preferably created by way of a DED method and particularly preferably by way of a WAAM method.

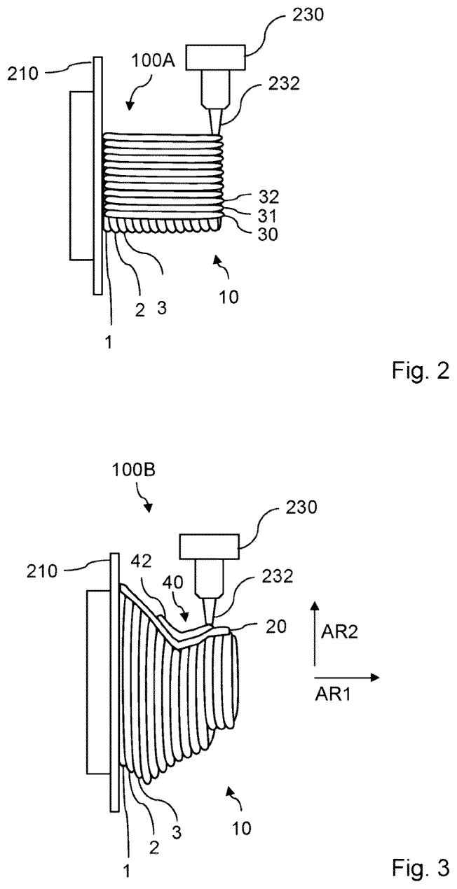

According to FIG. 1, the material webs are arranged spaced apart from one another on the outer contour of the main body 10. Alternatively, as shown in FIG. 2, it is also possible that the material webs adjoin or partially overlap one another and form a cohesive material layer (see material webs 30, 31, 32, . . . on the component 100A). Each material web 30, 31, 32 also extends transversely over multiple material layers 1, 2, 3 of the main body 10 and connects them to one another in this embodiment.

FIG. 3 shows an embodiment in which an auxiliary structure 40 is formed on the main body 10 of the component 100B. The auxiliary structure 40 comprises at least two material webs 20 and 42, which lie one on top of the other in a second construction direction AR2. The second construction direction AR2 differs in this case from the first construction direction AR1 and extends transversely thereto in the example shown. The material webs also extend over multiple material layers 1, 2, 3 and connect them to one another in this auxiliary structure.

To deposit the material web(s) 20, 22, 24, 30, 31, 32, 42, the construction platform 210 is preferably tilted and/or possibly rotated so that the material web(s) can preferably be deposited on the underlying main body 10 in the direction of gravity.

The component 100, 100A, 100B produced using the method can also comprise, in addition to the main body 10 and the at least one material web 20, 30, for example, component elements (not shown), which are also attached to the main body 10 during the production of the main body 10 or during the application of the at least one material web 20, 30. These component elements can be, for example, sheet metal components, preferably sheet-metal profiles or cast components. The component elements can be designed, for example, as attachment elements for attaching the component to further components.

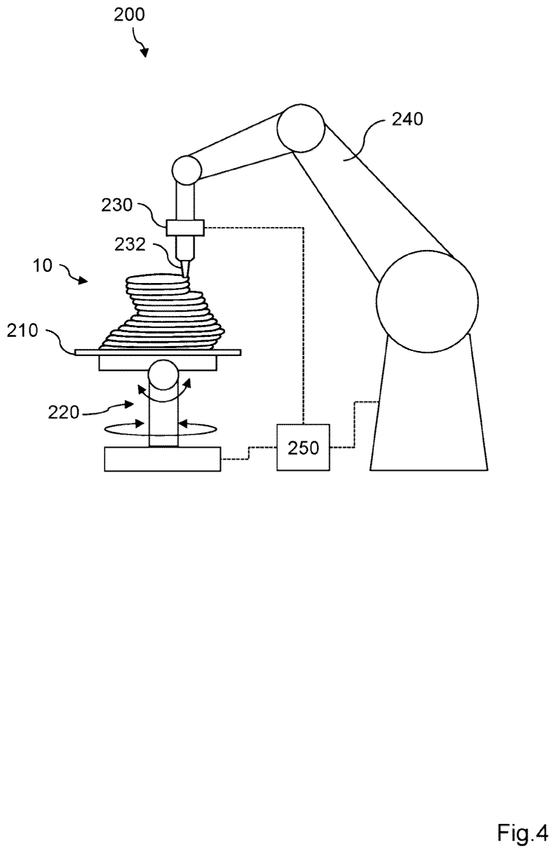

FIG. 4 shows an exemplary device 200 for producing a component, preferably according to one of the preceding exemplary embodiments. The device 200 includes a construction platform 210, which is arranged on a first positioning device 220. The first positioning device 220 is in particular a multiaxis industrial robot. The first positioning device 220 is configured to rotate and tilt the construction platform 210 in space.

Furthermore, the device 200 comprises a printing device 230 having a nozzle 232 for the emergence of a material strand, wherein the printing device 230 is configured to plasticize the material strand. For example, a wire material can be melted by way of electric arc or laser radiation to form the plasticized material strand. The printing device 230 is arranged on a second positioning device 240, which is configured to position the nozzle 232 in space. The second positioning device 240 is preferably a multiaxis industrial robot. In particular, the nozzle can be aligned in relation to the construction platform 210 or an already produced component section.

Furthermore, a control device 250 is provided, which is configured to actuate the first positioning device 220 and the second positioning device 240 in order to position the construction platform 210 and the nozzle 232 in predetermined positions and to operate the printing device 230. Construction platform and nozzle are preferably positioned in relation to one another so that the material web(s) 20, 22, 24, 30, 31, 32, 42 can be applied to the main body 10 at predetermined points and in particular using gravity.

The control device 250 can preferably be configured to move the construction platform 210 and the nozzle 232 at the same time, in particular while the printing device 230 is operated. In this way, an optimum deposit of the plasticized material strand to create the material web(s) 20, 22, 24, 30, 31, 32, 42 is even possible on complex geometries. For example, the positioning of construction platform and nozzle can take place so that the nozzle is guided at uniform distance and always perpendicular to the contour of the main body.

In some embodiments, the control device may comprise a processor and a memory for executing and storing software, algorithms, logic, and the like.

The above-described device is suitable in particular for creating the main body and depositing the material web(s) thereon and thus saving a handling step.

### List of Reference Signs

1, 2, 3 material layers

10 main body

20, 22, 24, 30, 31, 32, 42 material web

40 auxiliary structure

100, 100A, 100B component

200 device

210 construction platform

220 positioning device

230 printing device

232 nozzle

240 positioning device

250 control device

AR1, AR2 construction direction

1.-12. (canceled)

13. A method for producing a component comprising:
a) creating a main body in an additive manufacturing method, due to which the main body has a plurality of material layers, which lie one on top of another in a first construction direction, and
b) applying at least one material web to the outer contour of the main body by applying a plasticized material strand, so that the at least one material web connects several of the material layers to one another.

14. The method according to claim 13, wherein
the at least one material web is applied by way of a direct energy deposition method.

15. The method according to claim 13, wherein
multiple material webs are applied adjacent to one another on the outer contour of the main body.

16. The method according to claim 13, wherein
the at least one material web extends in the load direction of the component.

17. The method according to claim 13, further comprising:
c) creating an auxiliary structure by applying at least one further material web to the at least one material web such that two or more material webs lie one on top of another in a second construction direction, wherein the second construction direction differs from the first construction direction and extends transversely to the first construction direction.

18. The method according to claim 13, wherein
the material web forms at least one outer contour section of the component.

19. The method according to claim 13, wherein
the component is a vehicle body structure component or vehicle chassis component.

20. The method according to claim 13, wherein
the creation of the main body and application of the at least one material web are carried out by way of the same device.

21. A device for producing a component, the device comprising:
a construction platform, which is arranged on a first positioning device, wherein the first positioning device is configured to rotate and tilt the construction platform in space,
a printing device having a nozzle for the emergence of a material strand, wherein the printing device is configured to plasticize the material strand,
a second positioning device, on which the printing device is arranged and which is configured to position the nozzle in space, and
a control device, which is configured to actuate the first positioning device and the second positioning device in order to position the construction platform and the nozzle in predetermined positions and to operate the printing device.

22. The device according to claim 21, wherein
the first positioning device and/or the second positioning device is a multiaxis industrial robot.

23. The device according to claim 21, wherein
the printing device is configured to provide a plasticized material strand made of a plastic material or made of a metal material.

24. The device according to claim 21, wherein
the control device is configured to move the construction platform and the nozzle at the same time, while the printing device is operated.
